(19) United States
(12) Patent Application Publication
(10) Pub. No.: US 2026/0203373 A1
(43) Pub. Date: Jul. 16, 2026

(54) EFFICIENT SOFTMAX IMPLEMENTATION WITH REDUCED BITWIDTH

(71) Applicant: QUALCOMM Incorporated, San Diego, CA (US)

(72) Inventors: Nithin Seyon RAMESAN, San Mateo, CA (US); Sundar Rajan BALASUBRAMANIAN, Groton, MA (US); Ankita NAYAK, Milpitas, CA (US); Jainam SHAH, San Diego, CA (US); Aditya AWASTHI, San Diego, CA (US); Yuanning YU, Santa Clara, CA (US)

(21) Appl. No.: 19/016,671

(22) Filed: Jan. 10, 2025

(51) Int. Cl. G06F 17/18; G06N 20/00

(52) U.S. Cl. CPC G06F 17/18; G06N 20/00

(57) ABSTRACT

Certain aspects of the present disclosure provide techniques and apparatus for machine learning. In an example method, an input tensor is accessed as input to a softmax operation of a machine learning model. A first intermediate tensor is generated based on the input tensor using a non-uniform piecewise linear approximation (PWLA) of an exponent operation, and a second intermediate tensor is generated based on the first intermediate tensor using a normalization operation. A third intermediate tensor is generated based on the second intermediate tensor using an inverse operation. An output tensor is generated as output of the softmax operation based on the third intermediate tensor using a bitwise shift operation, and an output of the machine learning model is generated based on the output tensor.

### INTRODUCTION

Aspects of the present disclosure relate to machine learning.

A wide variety of machine learning model architectures have been developed to perform a variety of tasks, including generation of data such as text, images, video, audio, and the like, entity classification or detection, value or probability regression, and many others. Many modern model architectures, including transformer-based models, classification models, and the like, include one or more softmax operations or layers to process data. For example, attention layers often use softmax to convert raw attention scores into probability distributions over the input tokens. Examples of model architectures using softmax operations include language models (e.g., large language models (LLMs)), classification models, multi-head attention architectures, and the like.

### BRIEF SUMMARY

Certain aspects of the present disclosure provide a processor-implemented method, comprising: accessing an input tensor as input to a softmax operation of a machine learning model; generating a first intermediate tensor based on the input tensor using a non-uniform piecewise linear approximation (PWLA) of an exponent operation; generating a second intermediate tensor based on the first intermediate tensor using a normalization operation; generating a third intermediate tensor based on the second intermediate tensor using a PWLA of an inverse operation; generating an output tensor as output of the softmax operation based on the third intermediate tensor using a bitwise shift operation; and generating an output of the machine learning model based on the output tensor.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for improved machine learning using efficient softmax operations, according to some aspects of the present disclosure.

FIG. 2 depicts an example non-uniform piecewise linear approximation of a nonlinear function for efficient softmax operations, according to some aspects of the present disclosure.

FIG. 3 depicts an example workflow for efficient softmax operations using non-uniform piecewise linear approximations to nonlinear functions, according to some aspects of the present disclosure.

FIG. 4 is a flow diagram depicting an example method for efficient softmax operations using non-uniform piecewise linear approximations to nonlinear functions, according to some aspects of the present disclosure.

FIG. 5 is a flow diagram depicting an example method for efficient softmax operations, according to some aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning. Specifically, in some aspects of the present disclosure, more computationally efficient softmax operations are provided.

A softmax operation or layer generally includes two nonlinear functions: an exponent function and an inverse function. These nonlinear operations are computationally expensive. In some resource-constrained settings, efforts to improve the efficiency of softmax operations have included using nth-order polynomial approximations for these nonlinear operations. However, many current approaches fail to yield sufficiently robust performance across a range of input sizes (which is particularly important in transformer architectures).

In some aspects of the present disclosure, an efficient implementation of softmax is provided that performs consistently across a large range of input sizes, while using linear approximations for non-linear functions. In some aspects, the efficient softmax layer described herein can utilize low intermediate bitwidths (e.g., less than or equal to sixteen bits) for intermediate tensors, which can significantly reduce the physical area (e.g., on a chip) used by the softmax operation, the memory consumed by the operation, and/or the compute cost of the operation. In some aspects, robustness (e.g., consistently high signal-to-noise ratio) across a wide range of input sizes is particularly useful in transformer-based models, where the input sequence of tokens may have significant variation in length (e.g., ranging from a few tokens to several thousand tokens). The efficient softmax implementation described in more detail below can uniquely handle these varying input lengths, as compared to some conventional approaches.

In some aspects, a piecewise linear approximation (PWLA) is used as a fixed-point approximation for the non-linear functions of the softmax operation. In the exponent function (which is used by the softmax operation), the rate of change of the slope (e.g., the second derivative of the nonlinear function) increases as the input approaches zero. In some aspects, to more effectively approximate this function using a PWLA, non-uniformly distributed segments are used across the input range, as discussed in more detail below. This non-uniform PWLA can enable optimized (or at least improved) performance (e.g., more accurate approximation of the nonlinear function) without resorting to higher-order approximations (e.g., while still using linear approximations, which are significantly less computationally complex).

In some aspects, in addition to non-uniformly distributed linear segments, the PWLA can use two additional segments to provide “true zero” and “true one” outputs, as discussed in more detail below. For example, one additional linear segment of the non-uniform PWLA may be used to assign a fixed value of zero to all inputs less than a specified value, while a second linear segment is used to assign a fixed value of one to all inputs equal to (or greater than) another value (e.g., zero). The use of these “true zero” and “true one” segments can prevent or reduce error accumulation, particularly when very large or very small negative values are used as input to the non-uniform PWLA.

Generally, as discussed in more detail below, using non-uniform PWLA to implement softmax operations can significantly reduce the computational expense, chip area, memory usage, power consumption, and/or heat generation of the softmax operations. This can enable or improve the deployment and use of a wide variety of machine learning models, particularly on resource-constrained systems (e.g., battery-powered systems or computing systems with relatively limited resources, such as smartphones, tablets, and the like).

### Example Workflow for Improved Machine Learning Using Efficient Softmax Operations

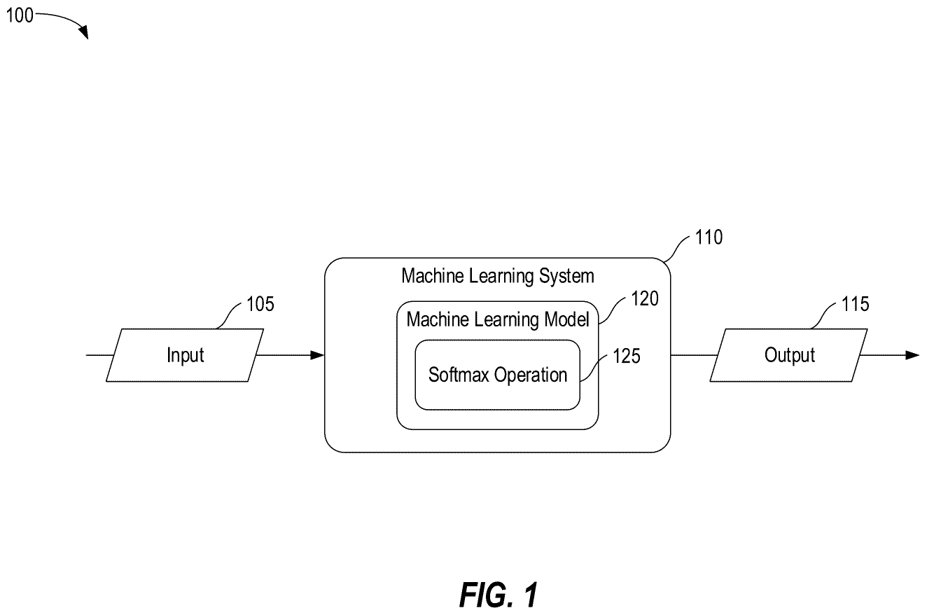

FIG. 1 depicts an example workflow 100 for improved machine learning using efficient softmax operations, according to some aspects of the present disclosure.

In the illustrated example, an input 105 can be accessed by a machine learning system 110, which generates a corresponding output 115. As used herein, “accessing” data may generally include receiving, requesting, obtaining, retrieving, generating, collecting, or otherwise gaining access to the data. For example, the machine learning system 110 may receive the input 105 from another computing system or application, from a user, may generate the input 105 locally, and the like.

The machine learning system 110 is generally representative of any computing system configured to perform the operations described herein. Although depicted as a discrete system for conceptual clarity, the operations of the machine learning system 110 may be implemented using hardware, software, or a combination of hardware and software, and may be combined or distributed across any number of components and systems (including cloud-based systems). In some aspects, the machine learning system 110 is an edge device or other computing device with relatively constrained resources (e.g., limited memory, compute power, energy, heat dissipation capacity, and the like).

In the illustrated example, the machine learning system 110 comprises or implements at least one machine learning model 120, where use of the machine learning model 120 includes application of at least one softmax operation 125. For example, the machine learning system 110 may train one or more machine learning models 120, and/or may use one or more pre-trained machine learning models 120 (e.g., models trained by other systems or devices) to perform a variety of tasks, depending on the particular implementation. In some aspects, as discussed above, a wide variety of tasks may be performed using model architectures that depend on or incorporate softmax operations 125. For example, language models (e.g., LLMs), classifier models, and the like rely on such operations.

As discussed above, some conventional softmax operations utilize two nonlinear functions that are difficult to implement efficiently. For example, one softmax algorithm may be defined as

$$σ ( {x}_{i} ) = \frac{{e}^{{x}_{i}}}{{\sum }_{j = 1}^{n} {e}^{{x}_{j}}} ,$$

where σ denotes the softmax operation and xᵢ is the i-th element of a tensor x. As is apparent, this formulation utilizes the exponent function, which is non-linear and difficult (or impossible) to perform efficiently on resource-constrained devices.

In the illustrated example, the softmax operation 125 corresponds to an efficient operation that uses one or more non-uniform PWLAs of nonlinear function(s), allowing the operation to be applied accurately while maintaining high signal-to-noise with low compute cost. In some aspects, the use of a non-uniform distribution of the linear segments of the PWLA enables improved approximation of the fast-changing non-linear functions (such as exponent) without resorting to higher order polynomials. Generally, the depicted softmax operation 125 can enable a fixed-point implementation with a relatively small memory and area footprint, as well as lightweight compute usage (as compared to some conventional softmax implementations). For example, in some aspects, intermediate data can be maintained in relatively small bitwidths (e.g., less than or equal to sixteen bits) while maintaining high accuracy.

In some aspects, as discussed in more detail below, the softmax operation 125 includes use of a non-uniform PWLA of the exponent operation, as well as a normalization operation to allow improved accuracy regardless of the number of terms or tokens used as input to the softmax operation 125, followed by a subsequent shift operation to compensate (or at least adjust) for the normalization. In some aspects, this formulation is coupled with “true zero” and/or “true one” segments in the non-uniform PWLA, further improving the operation's accuracy with minimal computational expense.

### Example Non-Uniform Piecewise Linear Approximation of a Nonlinear Function for Efficient Softmax Operations

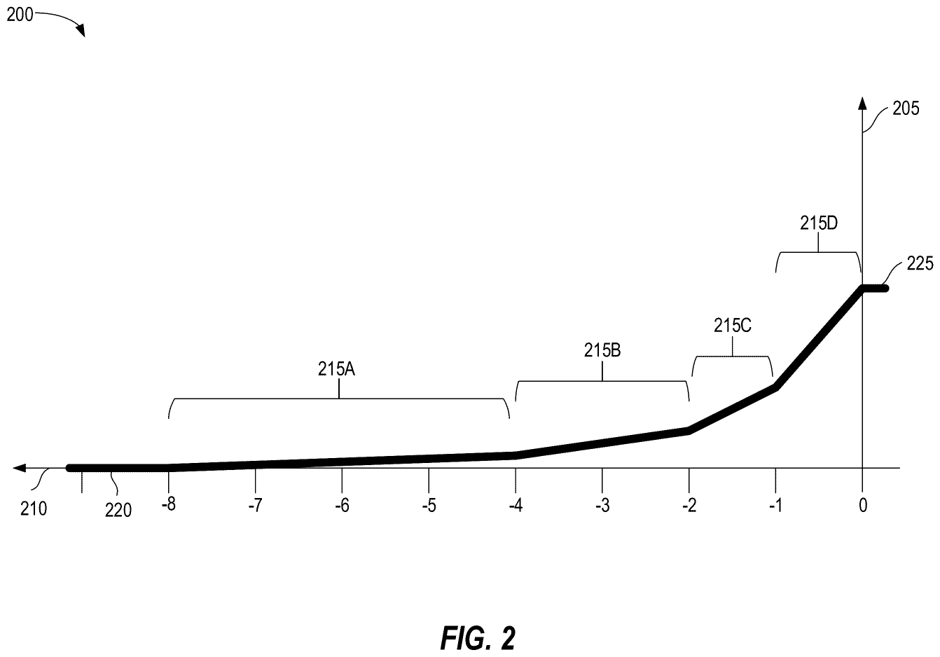

FIG. 2 depicts an example non-uniform piecewise linear approximation 200 of a nonlinear function for efficient softmax operations, according to some aspects of the present disclosure. In some aspects, the non-uniform PWLA 200 is used by the softmax operation 125 of FIG. 1.

The illustrated example depicts the non-uniform PWLA 200 using a graph where the horizontal axis 210 represents input values to the non-uniform PWLA 200 and the vertical axis 205 indicates the corresponding output value returned by the non-uniform PWLA 200. The non-uniform PWLA 200 comprises a set of linear segments which approximate the output of the exponent function. As discussed above, use of a piecewise linear approximation can enable highly accurate outputs with substantially reduced expense.

In the illustrated example, the non-uniform PWLA 200 is delineated into a set of input ranges 215A-D, where each input range 215 is represented using a corresponding linear segment. That is, each range 215 has a single linear segment, and if the input value falls within a given range, the output of the non-uniform PWLA 200 is determined using the corresponding linear segment. In the illustrated example, the non-uniform PWLA 200 is referred to as non-uniform because the linear segments are not uniformly distributed across the full input range. Specifically, as illustrated, one range 215A includes values from −8 to −4 (e.g., a range size of four), and represents all of these inputs using a single linear segment. The next range 215B covers input values from −4 to −2 (e.g., a range size of two), and also covers these inputs using a single linear segment. The ranges 215C and 215D cover inputs from −2 to −1, and from −1 to 0, respectively (each with a range size of one), and each uses a single linear segment.

That is, although the range 215A has a range size of four, the range 215B has a range size of two, and the ranges 215C and 215D each have a range size of one, each of these ranges uses a single linear segment. In this way, the linear segments may be arranged more densely in areas with shorter range sizes (e.g., where the exponent function changes more rapidly), while fewer linear segments may be dedicated to approximating areas where the exponent function changes more slowly. This allows for more efficient distribution of the linear approximations, resulting in improved accuracy of the non-uniform PWLA 200.

Although the illustrated example depicts each range 215 using a single linear segment for conceptual clarity, in some aspects, each range 215 may use multiple. For example, in some aspects, the non-uniform PWLA 200 may be defined such that values in the range 215A (greater than −8 and less than −4 (e.g., in the range (−8, −4))) are represented using 32 linear segments, values in the range 215B (greater than or equal to −4 and less than −2 (e.g., in the range [−4, −2))) are represented using 32 linear segments, values in the range 215C (greater than or equal to −2 and less than −1 (e.g., in the range [−2, −1))) are represented using 32 linear segments, and values in the range 215D (greater than −1 and less than 0 (e.g., in the range [−1, −0))) are represented using 32 linear segments.

That is, the non-uniform PWLA 200 may be defined such that ranges 215 of varying sizes each have an equal number of linear segments allocated. Due to the varying range size with matching number of segments, non-uniformity is implemented. As another example, in some aspects, the non-uniform PWLA 200 may be defined such that ranges 215 of matching size may have a differing number of linear segments. Varying the number of segments allocated to matching range sizes similarly implements non-uniformity.

In the illustrated example, the non-uniform PWLA 200 further includes two additional linear segments used to implement “true zero” and “true one” outputs. Specifically, one segment 220 is included to ensure that any input values less than or equal to −8 result in an output value of exactly zero, while a second segment 225 is included to ensure that an input value of zero (or greater than zero, in some aspects) results in an output value of exactly 1. In some aspects, the particular implementation of the softmax operation ensures that the input values are equal to or less than zero.

In the illustrated example, the use of the “true zero” segment 220 and the “true one” segment 225 can prevent (or at least reduce) error accumulation, particularly when very large or very small negative values are used as inputs to the non-uniform PWLA 200.

Although the illustrated example depicts contiguous linear segments (e.g., where the end points of each segment align with the end points of the adjacent segments) for conceptual clarity, in some aspects, some or all of the linear segments of the non-uniform PWLA 200 may be disjoint. Further, although the illustrated example depicts each linear segment as having a non-zero slope, in some aspects, the non-uniform PWLA 200 may be implemented as a set of horizontal line segments (each with a slope of zero).

### Example Workflow for Efficient Softmax Operations Using Non-Uniform Piecewise Linear Approximations to Nonlinear Functions

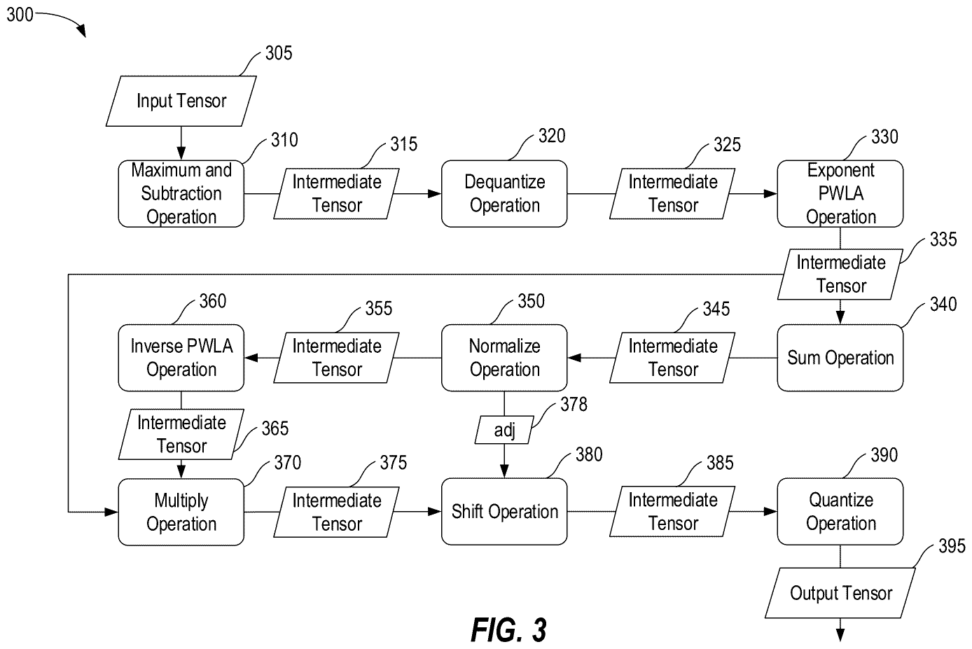

FIG. 3 depicts an example workflow 300 for efficient softmax operations using non-uniform piecewise linear approximations to nonlinear functions, according to some aspects of the present disclosure. In some aspects, the workflow 300 is performed by the machine learning system 110 of FIG. 1. For example, in some aspects, the workflow 300 provides additional detail for the softmax operation 125 of FIG. 1. Each of the depicted operations of the workflow 300 may be implemented using hardware, software, or a combination of hardware and software.

In the illustrated workflow 300, an input tensor 305 is accessed by a maximum and subtraction operation 310. The input tensor 305 may generally correspond to any data generated as part of processing input using the machine learning model (e.g., the machine learning model 120 of FIG. 1). For example, in the case of a classifier model, the input tensor 305 may be the output of a final layer of the model (e.g., output logits), and the workflow 300 may be used to generate final probabilities for each logit (using softmax). In some aspects, the input tensor 305 is a vector of values. In some aspects, the input tensor 305 may be a batch of vectors (e.g., in a batch processing environment), where the softmax operation is applied individually within each vector. For example, the input tensor 305 may be a n×k tensor, where the batch size is n and each vector (e.g., each row) has k classes or values.

The maximum and subtraction operation 310 may generally be used to find the maximum value of the input tensor 305 (or the maximum value of each row, in the case of a multi-vector batch). The maximum and subtraction operation 310 may then subtract the maximum value from each other value in the row. More specifically, given an input vector X, the maximum and subtraction operation 310 may compute X-max (X). The resulting data may be represented using an intermediate tensor 315.

In the illustrated example, the intermediate tensor 315 is accessed by a dequantize operation 320, which dequantizes the intermediate tensor 315 (if appropriate) and converts the (dequantized) tensor to a fixed-point precision (e.g., 16S12, representing a sixteen-bit signed fixed-point value having 12 fractional bits). This results in a second intermediate tensor 325.

The intermediate tensor 325 is then processed using an exponent PWLA operation 330 to generate another intermediate tensor 335. In some aspects, the exponent PWLA operation 330 performs or approximates an exponent function. In some aspects, the exponent PWLA operation 330 is implemented using the non-uniform PWLA 200 of FIG. 2. As discussed above, the exponent PWLA operation 330 generally computes (or approximates) e^{x} for each value x in the intermediate tensor 325 to generate the intermediate tensor 335.

As illustrated, the intermediate tensor 335 is then accessed by a sum operation 340 to generate an intermediate tensor 345. In some aspects, the sum operation 340 sums the exponent data (e.g., each value in the intermediate tensor 335) across the classes (e.g., summing the values within each row or vector, in the case of a multi-batch implementation), or simply summing the values of the intermediate tensor 335 in the case of a single-vector batch). As a result, the intermediate tensor 345 may include a single sum (or, in the case of a multi-vector batch implementation, may have a respective sum for each respective row or input vector in the batch).

The intermediate tensor 345 is then accessed by a normalize operation 350, which normalizes the intermediate tensor 345 to generate an intermediate tensor 355. In some aspects, the normalize operation 350 normalizes each value in the intermediate tensor 345 to a defined range, such as to a value between 0.5 and 1 (e.g., [0.5, 1)). In some aspects, the normalization is applied on a per-value basis to each value in the intermediate tensor 345 (regardless of whether the intermediate tensor 345 comprises a single vector or a batch of vectors). In some aspects, the range is a hyperparameter of the softmax operation. In some aspects, the normalize operation 350 can allow the accuracy of the softmax operation to remain high, regardless of the number of terms in the sum operation 340 (e.g., regardless of the size of the input to the softmax layer).

In some aspects, normalizing the intermediate tensor 345 (where each sum is represented using a signed fixed-point value), results in a mantissa and an exponent, with a sign bit adjustment value being derived based on the exponent. Effectively, the sign bit adjustment indicates the amount that the value was changed to normalize the value. As illustrated, this sign bit adjustment 378 (denoted “adj” in the illustrated example) is provided to a subsequent shift operation 380. As one simple example, suppose the intermediate tensor 345 is a single eight-bit number (e.g., in 8S3, or an eight bit number with three fractional bits) with a value of “00011111.” In some aspects, the goal of the normalization is to ensure that there is a single leading “0”. Hence, the intermediate tensor 345 will be shifted to the left by two places to obtain a normalized value of “01111100” (e.g., an 8S5 number, or an eight bit number with five fractional bits). In this example, the sign bit adjustment 378 is “−2” (where negative numbers indicate use of a right shift to compensate for the left shift performed during normalization).

As illustrated, the normalized intermediate tensor 355 is then accessed by an inverse PWLA operation 360 to generate an intermediate tensor 365. In some aspects, the inverse PWLA operation 360 performs or approximates the inverse operation or function. In some aspects, the inverse PWLA operation 360 may be implemented using a uniform or non-uniform piecewise linear approximation of the inverse function (e.g., using a set of linear segments across one or more input ranges). For example, the inverse PWLA operation 360 generally computes (or approximates)

$${x}^{- 1} ( e . g . , \frac{1}{x} )$$

for each value x in the intermediate tensor 355 to generate the intermediate tensor 365.

In the illustrated workflow 300, the intermediate tensor 365 and the intermediate tensor 335 (generated by the exponent PWLA operation 330) are then accessed by a multiply operation 370 to generate an intermediate tensor 375. In some aspects, the multiply operation 370 performs elementwise multiplication between the intermediate tensor 335 (e.g., e^{x} for each value x in the input) and the intermediate tensor

$$365 ( e . g . , \frac{1}{S}$$

where S is the normalized sum of the intermediate tensor 335 across all k classes).

The intermediate tensor 375 is then accessed by a shift operation 380. As discussed above, the shift operation 380 also accesses a sign bit adjustment 378, which defines the amount and/or direction to shift the values in the intermediate tensor 375. In some aspects, as discussed above, the shift operation 380 can compensate (or at least adjust) for the normalize operation 350. For example, continuing the above example, the sign bit adjustment of “−2” indicates to shift the intermediate tensor 375 right by two positions to compensate for the normalization. As illustrated, bitwise shifting the values of the intermediate tensor 375 by the sign bit adjustment 378 results in an intermediate tensor 385.

In the depicted workflow 300, the intermediate tensor 385 can then be processed by a quantize operation 390 to requantize (if appropriate) the data to generate the output tensor 395. As discussed above, the output tensor 395 is generally a highly accurate approximation of the result of applying a conventional softmax operation to the input tensor 305. However, the workflow 300 utilizes significantly fewer computational resources, such as through reduced compute, reduced power consumption, smaller memory footprint and/or chip area, and the like. For example, in some aspects, the input tensor 305 (e.g., the input to the softmax operation) and the output tensor 395 (e.g., the output from the softmax operation) may be encoded using one bitwidth (e.g., thirty-two bits), while some or all of the intermediate tensors 315, 325, 335, 345, 355, 365, 375, and/or 385 may be encoded using a relatively smaller bitwidth (e.g., eight or sixteen bits).

The output tensor 395 may then be used for any suitable purpose, depending on the particular implementation. For example in some aspects, the output tensor 395 is used as the final output of the machine learning model (e.g., the output 115 of FIG. 1). In some aspects, the output tensor 395 is used as output of the softmax layer and input to a subsequent operation or layer of the model, eventually resulting in the generation of a model output (based in part on the output tensor 395).

### Example Method for Efficient Softmax Operations Using Non-Uniform Piecewise Linear Approximations to Nonlinear Functions

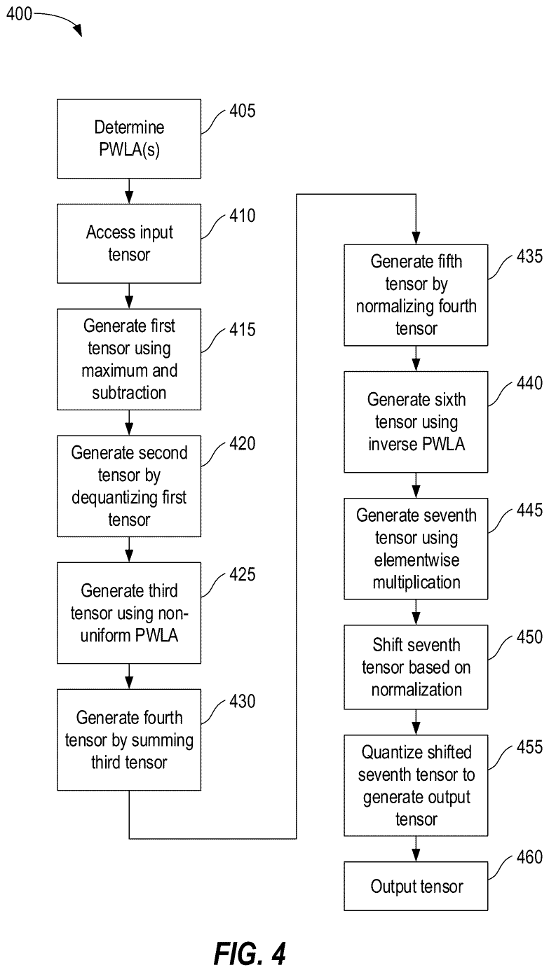

FIG. 4 is a flow diagram depicting an example method 400 for efficient softmax operations using non-uniform piecewise linear approximations to nonlinear functions, according to some aspects of the present disclosure. In some aspects, the method 400 is performed by the machine learning system 110 of FIG. 1. For example, in some aspects, the method 400 provides additional detail for the softmax operation 125 of FIG. 1.

At block 405, the machine learning system 110 determines one or more PWLA(s) to be used to approximate or perform one or more nonlinear functions (e.g., as part of a softmax operation). For example, as discussed above, the machine learning system 110 may identify a non-uniform PWLA (e.g., the non-uniform PWLA 200 of FIG. 2) to implement the exponent operations of a softmax layer, as well as a second PWLA to implement the inverse function. In some aspects, the PWLAs (e.g., the particular number and distribution of linear segments) may be defined as hyperparameters.

At block 410, the machine learning system 110 accesses an input tensor (e.g., the input tensor 305 of FIG. 3) for a softmax operation of a machine learning model. For example, as discussed above, the input tensor may be generated by a previous layer or operation of the model.

At block 415, the machine learning system 110 generates a first tensor (e.g., the intermediate tensor 315 of FIG. 3) by processing the input tensor using a maximum and subtraction operation (e.g., the maximum and subtraction operation 310 of FIG. 3). For example, as discussed above, given an input tensor X=(x₁, x₂, . . . , xₖ), the machine learning system 110 may compute the first tensor as (x₁−max(X), x₂−max(X), . . . xₖ−max(X)).

At block 420, the machine learning system 110 generates a second tensor (e.g., the intermediate tensor 325 of FIG. 3) by dequantizing the second tensor and/or converting or bringing the second tensor to a fixed-point encoding (e.g., using the dequantize operation 320 of FIG. 3), as discussed above.

At block 425, the machine learning system 110 generates a third tensor (e.g., the intermediate tensor 335 of FIG. 3) using a non-uniform PWLA (e.g., the exponent PWLA operation 330 of FIG. 3 and/or the non-uniform PWLA 200 of FIG. 2). For example, given a dequantized and fixed-point tensor Xᵣ=(x_{r,1}, x_{r,2}, . . . , x_{r,k}), the machine learning system 110 may generate the third tensor as (exp(x_{r,1}), exp(x_{r,2}), . . . , exp(x_{r,k})).

At block 430, the machine learning system 110 generates a fourth tensor (e.g., the intermediate tensor 345 of FIG. 3) by summing the elements of the third tensor (e.g., using the sum operation 340 of FIG. 3). For example, the machine learning system 110 may compute

$$S = {\sum }_{1 = 1}^{k} exp ( {x}_{r , 1} ) .$$

At block 435, the machine learning system 110 generates a fifth tensor (e.g., the intermediate tensor 355 of FIG. 3) based on normalizing the fourth tensor (e.g., using the normalize operation 350 of FIG. 3). For example, as discussed above, the machine learning system 110 may normalize the sum to a value between about 0.5 (e.g., within +0.05 of 0.5, within ±0.1 of 0.5, and the like) and about 1 (e.g., within ±0.05 of 1, within ±0.1 of 1, and the like). In some aspects, as discussed above, normalizing the fourth tensor includes generating a sign bit adjustment value (e.g., the sign bit adjustment 378) indicating the magnitude that the value(s) were changed to normalize the tensor to the desired range.

At block 440, the machine learning system 110 generates a sixth tensor (e.g. the intermediate tensor 365 of FIG. 3) by processing the fifth tensor using a PWLA of an inverse function (e.g., the inverse PWLA operation 360). For example, given a normalized sum Sn, the machine learning system may compute (or approximate) the inverse

$$\frac{1}{{S}_{n}} .$$

At block 445, the machine learning system 110 generates a seventh tensor (e.g., the intermediate tensor 375 of FIG. 3) using an elementwise multiplication operation (e.g., the multiply operation 370 of FIG. 3) based on multiplying the sixth tensor and the third tensor. For example, as discussed above, the machine learning system 110 may generate the third tensor as

$$( \frac{exp ( {x}_{r , 1} )}{{S}_{n}} , \frac{exp ( {x}_{r , 2} )}{{S}_{n}} , … , \frac{exp ( {x}_{r , k} )}{{S}_{n}} ) .$$

At block 450, the machine learning system 110 generates a shifted seventh tensor (e.g., an eighth tensor, such as the intermediate tensor 385 of FIG. 3) by shifting the seventh tensor based on the normalization (e.g., by the amount indicated in the sign bit adjustment value generated at block 435). As discussed above, this can allow the machine learning system 110 to compensate (or at least adjust) for the normalization.

At block 455, the machine learning system 110 quantizes the shifted seventh tensor (e.g., using the quantize operation 390 of FIG. 3) to generate an output tensor (e.g., the output tensor 395 of FIG. 3). As discussed above, the output tensor generally approximates (e.g., is used as) the result of applying a softmax operation (e.g., the softmax operation 125 of FIG. 1) to the input tensor.

At block 460, the machine learning system 110 outputs the output tensor. For example as discussed above, the output tensor may be the output of the machine learning model, or may be used as input to a subsequent model layer or component in order to generate an eventual model output.

### Example Method for Efficient Softmax Operations

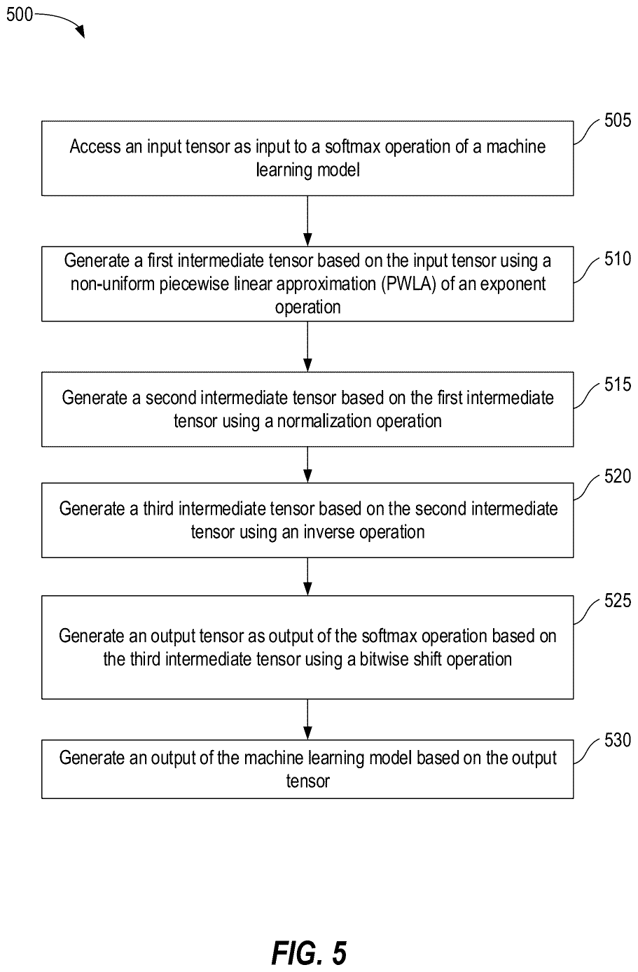

FIG. 5 is a flow diagram depicting an example method 500 for efficient softmax operations, according to some aspects of the present disclosure.

At block 505, an input tensor (e.g., the input tensor 305 of FIG. 3) is accessed as input to a softmax operation (e.g., the softmax operation 125 of FIG. 1) of a machine learning model (e.g., the machine learning model 120 of FIG. 1).

At block 510, a first intermediate tensor (e.g., the intermediate tensor 335 of FIG. 3) is generated based on the input tensor using a non-uniform piecewise linear approximation (PWLA) of an exponent operation (e.g., the non-uniform PWLA 200 of FIG. 2 and/or the exponent PWLA operation 330 of FIG. 3).

At block 515, a second intermediate tensor (e.g., the intermediate tensor 355 of FIG. 3) is generated based on the first intermediate tensor using a normalization operation (e.g., the normalize operation 350 of FIG. 3).

At block 520, a third intermediate tensor (e.g., the intermediate tensor 365 of FIG. 3) is generated based on the second intermediate tensor using an inverse operation (e.g., the inverse PWLA operation 360 of FIG. 3).

At block 525, an output tensor (e.g., the output tensor 395 of FIG. 3) is generated as output of the softmax operation based on the third intermediate tensor using a bitwise shift operation (e.g., the shift operation 380 of FIG. 3).

At block 530, an output (e.g., the output 115 of FIG. 1) of the machine learning model is generated based on the output tensor.

In some aspects, the non-uniform PWLA comprises a first plurality of linear segments for a first range (e.g., the range 215B of FIG. 2) and a second plurality of linear segments for a second range (e.g., the range 215A of FIG. 2), the first plurality of linear segments comprises a first number of linear segments, the second plurality of linear segments comprises the first number of linear segments, and the first range is smaller than the second range.

In some aspects, the non-uniform PWLA comprises a first plurality of linear segments for a first range (e.g., the range 215C of FIG. 2) and a second plurality of linear segments for a second range (e.g., the range 215D of FIG. 2), the first plurality of linear segments comprises a first number of linear segments, the second plurality of linear segments comprises a second number of linear segments larger than the first number of linear segments, and a size of the first range is equal to a size of the second range.

In some aspects, the non-uniform PWLA comprises a first linear segment (e.g., the segment 220 of FIG. 2) having an output value of zero for input values less than a first value and a second linear segment (e.g., the segment 225 of FIG. 2) having an output value of one for input values greater than or equal to a second value.

In some aspects, the first, second, and third intermediate tensors are encoded using a first bitwidth, and the output tensor is encoded using a second bitwidth greater than the first bitwidth.

In some aspects, generating the second intermediate tensor comprises summing elements of the first intermediate tensor (e.g., using the sum operation 340 of FIG. 3) to generate a tensor sum (e.g., the intermediate tensor 345 of FIG. 3) and processing the tensor sum using the normalization operation to generate the second intermediate tensor.

In some aspects, processing the tensor sum using the normalization operation comprises normalizing values of the tensor sum to a range between 0.5 and 1.

In some aspects, generating the output tensor comprises elementwise multiplying the first intermediate tensor with the third intermediate tensor (e.g., using the multiply operation 370 of FIG. 3) to generate a fourth intermediate tensor (e.g., the intermediate tensor 375 of FIG. 3) and processing the fourth intermediate tensor using the bitwise shift operation to generate the output tensor.

In some aspects, the bitwise shift operation shifts values of the fourth intermediate tensor by a sign bit adjustment value (e.g., the sign bit adjustment 378 of FIG. 3) determined based on the normalization operation.

### Example Processing System for Machine Learning

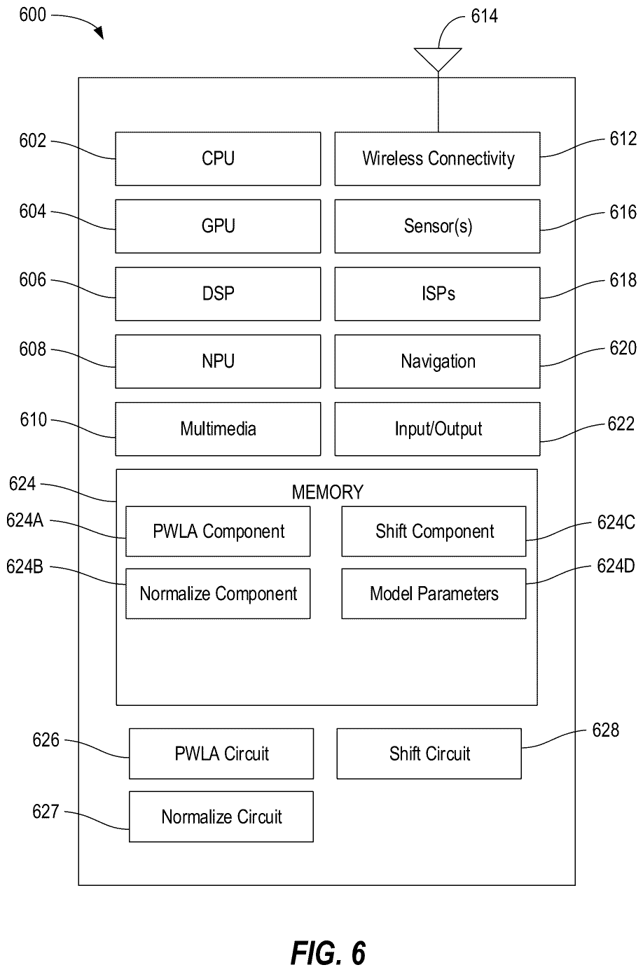

FIG. 6 depicts an example processing system 600 configured to perform various aspects of the present disclosure, including, for example, the techniques and methods described with respect to FIGS. 1-5. In some aspects, the processing system 600 may correspond to a machine learning system. For example, the processing system 600 may correspond to the machine learning system 110 of FIG. 1, and/or the machine learning system discussed above with reference to FIGS. 2-6. Although depicted as a single system for conceptual clarity, in some aspects, as discussed above, the components described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of a memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as the NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a PWLA component 624A, a normalize component 624B, and a shift component 624C. Although not depicted in the illustrated example, the memory 624 may also include other components, such as an inferencing or generation component to manage the generation of output data using generative machine learning models, a training component used to train or update the generative machine learning model(s), and the like. Though depicted as discrete components for conceptual clarity in FIG. 6, the illustrated components (and others not depicted) may be collectively or individually implemented in various aspects.

Further, as illustrated, the memory 624 may also include various data, such as a set of model parameters 624D (e.g., parameters of one or more machine learning models that include softmax operations), training data, and the like.

The processing system 600 further comprises a PWLA circuit 626, a normalize circuit 627, and a shift circuit 628. The depicted circuits, and others not depicted (such as an inferencing circuit), may be configured to perform various aspects of the techniques described herein.

The PWLA component 624A and/or the PWLA circuit 626 (which may correspond to the non-uniform PWLA 200 of FIG. 2, the exponent PWLA operation 330 of FIG. 3, and/or the inverse PWLA operation 360 of FIG. 3) may define piecewise linear approximations of nonlinear function used in conventional softmax layers, as discussed above. For example, the PWLA component 624A and/or the PWLA circuit 626 may use a non-uniform distribution of linear segments across a set of input ranges to approximate the exponent function. In some aspects, as discussed above, the approximation may further include a “true zero” segment for input values less than a first threshold (e.g., −8) and/or a “true one” segment for input values greater than or equal to a second threshold (e.g., 0).

The normalize component 624B and/or the normalize circuit 627 (which may correspond to the normalize operation 350 of FIG. 3) may be used to normalize input data to a defined range (e.g., between 0.5 and 1), as discussed above. For example, the normalize component 624B and/or the normalize circuit 627 may normalize input data to allow subsequent inverse operations (e.g., the inverse PWLA operation 360 of FIG. 3) to be performed more accurately.

The shift component 624C and/or the shift circuit 628 (which may correspond to the shift operation 380 of FIG. 3) may be used to shift tensors to account for previous normalization operations, as discussed above. For example, the shift component 624C and/or the shift circuit 628 may shift input tensors by the amount that the data was normalized (e.g., based on the sign bit adjustment 378) to compensate (or at least adjust) for the normalization.

Though depicted as separate components and circuits for clarity in FIG. 6, the PWLA circuit 626, the normalize circuit 627, and the shift circuit 628 may collectively or individually be implemented in other processing devices of the processing system 600, such as within the CPU 602, the GPU 604, the DSP 606, the NPU 608, and the like.

Generally, the processing system 600 and/or components thereof may be configured to perform the methods described herein.

Notably, in other aspects, aspects of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 maybe distributed between multiple devices.

### Example Clauses

Implementation examples are described in the following numbered clauses:

Clause 1: A method, comprising: accessing an input tensor as input to a softmax operation of a machine learning model; generating a first intermediate tensor based on the input tensor using a non-uniform piecewise linear approximation (PWLA) of an exponent operation; generating a second intermediate tensor based on the first intermediate tensor using normalization operation; generating a third intermediate tensor based on the second intermediate tensor using an inverse operation; generating an output tensor as output of the softmax operation based on the third intermediate tensor using a bitwise shift operation; an generating an output of the machine learning model based on the output tensor.

Clause 2: A method according to Clause 1, wherein: the non-uniform PWLA comprises a first plurality of linear segments for a first range and a second plurality of linear segments for a second range, the first plurality of linear segments comprises a first number of linear segments, the second plurality of linear segments comprises the first number of linear segments, and the first range is smaller than the second range.

Clause 3: A method according to any of Clauses 1-2, wherein: the non-uniform PWLA comprises a first plurality of linear segments for a first range and a second plurality of linear segments for a second range, the first plurality of linear segments comprises a first number of linear segments, the second plurality of linear segments comprises a second number of linear segments larger than the first number of linear segments, and a size of the first range is equal to a size of the second range.

Clause 4: A method according to any of Clauses 1-3, wherein the non-uniform PWLA comprises: a first linear segment having an output value of zero for input values less than a first value; and a second linear segment having an output value of one for input values greater than or equal to a second value.

Clause 5: A method according to any of Clauses 1-4, wherein: the first, second, and third intermediate tensors are encoded using a first bitwidth; and the output tensor is encoded using a second bitwidth greater than the first bitwidth.

Clause 6: A method according to any of Clauses 1-5, wherein generating the second intermediate tensor comprises: summing elements of the first intermediate tensor to generate a tensor sum; and processing the tensor sum using the normalization operation to generate the second intermediate tensor.

Clause 7: A method according to Clause 6, wherein processing the tensor sum using the normalization operation comprises normalizing values of the tensor sum to a range between 0.5 and 1.

Clause 8: A method according to any of Clauses 1-7, wherein generating the output tensor comprises: elementwise multiplying the first intermediate tensor with the third intermediate tensor to generate a fourth intermediate tensor; and processing the fourth intermediate tensor using the bitwise shift operation to generate the output tensor.

Clause 9: A method according to Clause 8, wherein the bitwise shift operation shifts values of the fourth intermediate tensor by a sign bit adjustment value determined based on the normalization operation.

Clause 10: A processing system comprising: a memory comprising processor-executable instructions; and one or more processors coupled to the one or more memories and configured to execute the processor-executable instructions and cause the processing system to perform a method in accordance with any of Clauses 1-9.

Clause 11: A processing system comprising means for performing a method in accordance with any of Clauses 1-9.

Clause 12: A non-transitory computer-readable medium comprising computer-executable instructions that, when executed by one or more processors of a processing system, cause the processing system to perform a method in accordance with any of Clauses 1-9.

Clause 13: A computer program product embodied on a computer-readable storage medium comprising code for performing a method in accordance with any of Clauses 1-9.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning, comprising:
one or more memories comprising processor-executable instructions; and
one or more processors coupled to the one or more memories and configured to execute the processor-executable instructions and cause the processing system to:
access an input tensor as input to a softmax operation of a machine learning model;
generate a first intermediate tensor based on the input tensor using a non-uniform piecewise linear approximation (PWLA) of an exponent operation;
generate a second intermediate tensor based on the first intermediate tensor using a normalization operation;
generate a third intermediate tensor based on the second intermediate tensor using an of an inverse operation;
generate an output tensor as output of the softmax operation based on the third intermediate tensor using a bitwise shift operation; and
generate an output of the machine learning model based on the output tensor.

2. The processing system of claim 1, wherein:
the non-uniform PWLA comprises a first plurality of linear segments for a first range and a second plurality of linear segments for a second range,
the first plurality of linear segments comprises a first number of linear segments,
the second plurality of linear segments comprises the first number of linear segments, and
the first range is smaller than the second range.

3. The processing system of claim 1, wherein:
the non-uniform PWLA comprises a first plurality of linear segments for a first range and a second plurality of linear segments for a second range,
the first plurality of linear segments comprises a first number of linear segments,
the second plurality of linear segments comprises a second number of linear segments larger than the first number of linear segments, and
a size of the first range is equal to a size of the second range.

4. The processing system of claim 1, wherein the non-uniform PWLA comprises:
a first linear segment having an output value of zero for input values less than a first value; and
a second linear segment having an output value of one for input values greater than or equal to a second value.

5. The processing system of claim 1, wherein:
the first, second, and third intermediate tensors are encoded using a first bitwidth; and
the output tensor is encoded using a second bitwidth greater than the first bitwidth.

6. The processing system of claim 1, wherein, to generate the second intermediate tensor, the one or more processors are configured to execute the processor-executable instructions and cause the processing system to:
sum elements of the first intermediate tensor to generate a tensor sum; and
process the tensor sum using the normalization operation to generate the second intermediate tensor.

7. The processing system of claim 6, wherein, to process the tensor sum using the normalization operation, the one or more processors are configured to execute the processor-executable instructions and cause the processing system to normalize values of the tensor sum to a range between 0.5 and 1.

8. The processing system of claim 1, wherein, to generate the output tensor, the one or more processors are configured to execute the processor-executable instructions and cause the processing system to:
elementwise multiply the first intermediate tensor with the third intermediate tensor to generate a fourth intermediate tensor; and
process the fourth intermediate tensor using the bitwise shift operation to generate the output tensor.

9. The processing system of claim 8, wherein the bitwise shift operation shifts values of the fourth intermediate tensor by a sign bit adjustment value determined based on the normalization operation.

10. A processor-implemented method of machine learning, comprising:
accessing an input tensor as input to a softmax operation of a machine learning model;
generating a first intermediate tensor based on the input tensor using a non-uniform piecewise linear approximation (PWLA) of an exponent operation;
generating a second intermediate tensor based on the first intermediate tensor using a normalization operation;
generating a third intermediate tensor based on the second intermediate tensor using an inverse operation;
generating an output tensor as output of the softmax operation based on the third intermediate tensor using a bitwise shift operation; and
generating an output of the machine learning model based on the output tensor.

11. The processor-implemented method of claim 10, wherein:
the non-uniform PWLA comprises a first plurality of linear segments for a first range and a second plurality of linear segments for a second range,
the first plurality of linear segments comprises a first number of linear segments,
the second plurality of linear segments comprises the first number of linear segments, and
the first range is smaller than the second range.

12. The processor-implemented method of claim 10, wherein:
the non-uniform PWLA comprises a first plurality of linear segments for a first range and a second plurality of linear segments for a second range,
the first plurality of linear segments comprises a first number of linear segments,
the second plurality of linear segments comprises a second number of linear segments larger than the first number of linear segments, and
a size of the first range is equal to a size of the second range.

13. The processor-implemented method of claim 10, wherein the non-uniform PWLA comprises:
a first linear segment having an output value of zero for input values less than a first value; and
a second linear segment having an output value of one for input values greater than or equal to a second value.

14. The processor-implemented method of claim 10, wherein:
the first, second, and third intermediate tensors are encoded using a first bitwidth; and
the output tensor is encoded using a second bitwidth greater than the first bitwidth.

15. The processor-implemented method of claim 10, wherein generating the second intermediate tensor comprises:
summing elements of the first intermediate tensor to generate a tensor sum; and
processing the tensor sum using the normalization operation to generate the second intermediate tensor.

16. The processor-implemented method of claim 15, wherein processing the tensor sum using the normalization operation comprises normalizing values of the tensor sum to a range between 0.5 and 1.

17. The processor-implemented method of claim 10, wherein generating the output tensor comprises:
elementwise multiplying the first intermediate tensor with the third intermediate tensor to generate a fourth intermediate tensor; and
processing the fourth intermediate tensor using the bitwise shift operation to generate the output tensor.

18. The processor-implemented method of claim 17, wherein the bitwise shift operation shifts values of the fourth intermediate tensor by a sign bit adjustment value determined based on the normalization operation.

19. A processing system, comprising:
means for accessing an input tensor as input to a softmax operation of a machine learning model;
means for generating a first intermediate tensor based on the input tensor using a non-uniform piecewise linear approximation (PWLA) of an exponent operation;
means for generating a second intermediate tensor based on the first intermediate tensor using a normalization operation;
means for generating a third intermediate tensor based on the second intermediate tensor using an inverse operation;
means for generating an output tensor as output of the softmax operation based on the third intermediate tensor using a bitwise shift operation; and
means for generating an output of the machine learning model based on the output tensor.

20. The processing system of claim 19, wherein the non-uniform PWLA comprises:
a first linear segment having an output value of zero for input values less than a first value; and
a second linear segment having an output value of one for input values greater than or equal to a second value.
